(19) United States
(12) Patent Application Publication
(10) Pub. No.: US 2014/0338527 A1
(43) Pub. Date: Nov. 20, 2014

(54) PISTON PUMP AND PISTON ASSEMBLY THEREFOR

(71) Applicant: GE HEALTHCARE BIO-SCIENCES AB, UPPSALA (SE)

(72) Inventor: Mats Lundkvist, Uppsala (SE)

(73) Assignee: GE HEALTHCARE BIO-SCIENCES AB, UPPSALA (SE)

(21) Appl. No.: 14/344,713

(22) PCT Filed: Sep. 27, 2012
(86) PCT No.: PCT/EP2012/069151

§ 371 Date: Mar. 13, 2014

(30) Foreign Application Priority Data
Sep. 30, 2011 (GB) 1116907.5

(51) Int. Cl. F16J 1/00; F16J 15/00

(52) U.S. Cl. CPC F16J 1/005; F16J 15/00
USPC 92/172

(57) ABSTRACT

Disclosed is piston pump (10) and piston assembly (30) for such a pump. The piston pump includes a cylinder (20) having an inner wall surface (22) formed around an axis A of the cylinder, and a piston assembly (30) for sliding along said cylinder axis, said piston assembly includes a slideable flexible seal (34) in generally sealing contact with said inner wall surface, and a seal mounting (44), said seal mounting having a plurality of circumferentially arranged members (37) moveable radially of said axis to increase or decrease the size of the seal.

### FIELD OF THE INVENTION

The present invention relates principally to a piston pump and in particular to a piston assembly for such a pump.

### BACKGROUND OF THE INVENTION

In many bio-chemical processes such as chromatography, it is necessary to move liquids from one area to another. It is very important that the means for moving the liquids is able to generate both relatively low (1 Bar and less) and relatively high (around 200 Bar) gauge pressures, in order to be versatile. In addition, such pumps need to develop suction (negative gauge pressures) also. Piston pumps have been found to work reasonably well, but leakage past sliding piston seals has been a problem, particularly at high pressures.

Modern commercial pressures dictate that it is desirable to get fully working products to market quickly. Where piston pumps are needed, it is common to use piston seals formed from elastomeric mouldings. If these seals are found to leak during testing, then significant delays could be experienced while new seals are produced in an attempt to eliminate seal leakage. Once in operation, seals can become worn and leak, so seal life is an important consideration also.

Further, where scarce or expensive liquids are used, it is undesirable to have wastage. One source of wastage in a piston pump is the dead space at the end of the stroke of a piston.

In addition, the means for moving the liquids needs to be easily flushed and cleaned. Complicated seal shapes not only have higher dead space, but are also harder to clean thoroughly.

Embodiments of the invention provide a piston pump and piston assembly which address the problems mentioned above.

### SUMMARY OF THE INVENTION

In accordance with a first aspect of the invention, there is provided a piston pump including: a cylinder having an inner wall surface formed around an axis of the cylinder; and a piston assembly for sliding along said cylinder axis, said piston assembly including a slideable flexible seal in generally sealing contact with said inner wall surface, and a seal mounting, said seal mounting having a plurality of circumferentially arranged members moveable radially of said axis to increase or decrease the size of the seal.

In an embodiment, said plurality of members each include a surface which collectively provide a conical formation and the piston assembly further includes an adjuster moveable along the axis thereby to act on the conical formation to cause said increase or decrease in size of the seal.

Preferably, the conical formation is male and the adjuster is female, and preferably, the piston further includes a rocker about which the members may pivot in use.

Preferably the rocker has a stem for driving the piston, and the adjuster is mounted on the rocker at said stem.

Preferably, the plurality of members forming the seal mounting are resiliently attached together.

Preferably the seal has a generally flat end supported by ends of the plurality of members.

In accordance with a second aspect of the invention, there is provided a piston assembly for sliding along a cylinder axis, said piston assembly including a slideable flexible seal for generally sealing contact with the cylinder wall surface, and a seal mounting, said seal mounting having a plurality of circumferentially arranged members moveable radially of said axis to increase or decrease the size of the seal.

Preferably the piston assembly includes any one or more features of the first aspect.

In accordance with a third aspect of the invention, there is provided a piston seal when used in the pump of the first aspect, or the with the piston assembly of the second aspect.

In accordance with a fourth aspect of the invention, there is provided chromatography apparatus employing a pump according to the first aspect.

### BRIEF DESCRIPTION OF THE DRAWINGS

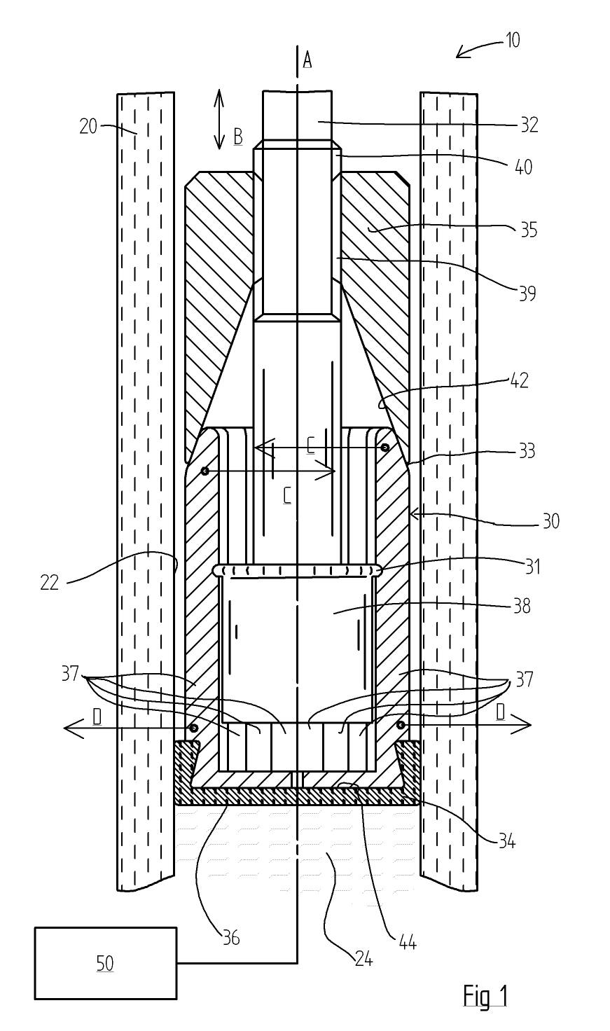

The invention is summarised above, but may be put into effect in numerous ways, one illustrative embodiment being described below, with reference to the drawing, wherein FIG. 1 shows a cross section through the pump of the invention, connected to chromatography apparatus.

### DETAILED DESCRIPTION OF THE INVENTION

FIG. 1 shows a piston pump 10. The pump includes a cylinder 20 which has an axis A, and a piston assembly 30. The piston can slide in the cylinder along axis A in the direction of the arrows B, in use, driven by a motor (not shown) or the like, connected to a stem 32 of the piston assembly 30. This motion provides pressure changes (including suction) at the head space 24 of the cylinder, which in turn can cause fluid flow into (or out of) bio-chemical apparatus, in this case chromatography apparatus 50.

The piston assembly 30 has a flexible elastomeric seal 34 which seals and slides against an inner wall surface 22 of the cylinder. This seal has a flat leading face 36 which extends across the whole of the head space 24. This arrangement reduces the dead space when the piston reaches the end of its stroke. The flexible seal 34 is able to maintain its flat face 34 because it is supported by a seal mounting 44.

The seal mounting 44 is formed from a plurality of resilient, or resiliently connected members 37, arranged circumferentially about the axis A, like the fingers of a machine tool collet. 12 members are envisaged, but more or less members will be adequate. The members of the mounting 44 are supported on a rocker 38 which is located at the end of the stem 32. The rocker acts as a pivot for each member at a pivot point 31. The members extend beyond the pivot point 31 and at the ends distal from the seal, taper toward the axis A, together forming a male conical formation 33.

The piston assembly includes also an adjuster 35, having a threaded portion 39 which engages with a threads 40 formed on the stem 32. The adjuster includes also a female conical formation 42 which engages with the male conical formation 33 formed by the members.

Since it is desirable to find the correct degree of sealing force which force may need to be adjusted to meet different working requirements in different apparatus, then the this force is adjustable by means of rotating the adjuster 35, to cause its movement on the threads 40, and movement relative to the stem 32 and rocker 38. Moving the adjuster toward the rocker 38 causes the conical formations to engage, and the upper ends of the members 37 to be forced in the direction of arrows C. In turn the members 37 pivot about pivot point 31 and move radially outwardly at the seal 34 in the direction of arrows D. Opposite movements are generated when the adjuster is moved away from the rocker 38.

Thereby an adjustable sealing force can be produced at the seal 34. In practice, once the correct sealing force is established, there is no need for the threads 39/40 and either a fixed position ‘adjuster’ 35 can be used, or a simpler arrangement can be used, for example, shims or spacer washers could be used to provide the correct spacing.

The above embodiment is an illustrative example of the invention. Modifications, additions or omissions are possible without departing from the scope of the invention, which is defined in the accompanying claims. For example, it is envisaged that the cylinder and seal will be generally circular in cross section, although other shapes are possible. Other than the seal 34, it is envisaged that metals and plastics materials will be employed for the cylinder and piston assembly, but other materials such as ceramic materials could be employed, for example where corrosive or invasive liquids need to be pumped. It is envisaged that the seal material may be any flexible elastomeric material including polymers such as natural rubber, EPDM, Neoprene, Silicone, Urethane, Ethylene Propylene (EP) or the like, or combinations of said polymers.

1. A piston pump including: a cylinder having an inner wall surface formed around an axis of the cylinder; and a piston assembly for sliding along said cylinder axis, said piston assembly including a slideable flexible seal in generally sealing contact with said inner wall surface, and a seal mounting, said seal mounting having a plurality of circumferentially arranged members moveable radially of said axis to increase or decrease the size of the seal.

2. A pump as claimed in claim 1, wherein said plurality of members each include a surface which collectively provide a conical formation and the piston assembly further includes an adjuster moveable along the axis thereby to act on the conical formation to cause said increase or decrease in size of the seal.

3. A pump as claimed in claim 2, wherein the conical formation is male and the adjuster is female, and optionally, the piston further includes a rocker about which the members may pivot in use.

4. A pump as claimed in claim 3, wherein the rocker has a stem for driving the piston, and the adjuster is mounted on the rocker at said stem.

5. A pump as claimed in claim 1, wherein the plurality of members forming the seal mounting are resiliently attached together.

6. A pump as claimed in claim 1, wherein the seal has a generally flat end supported by ends of the plurality of members.

7. A piston assembly for sliding along a cylinder axis, said piston assembly including a slideable flexible seal for generally sealing contact with the cylinder wall surface, and a seal mounting, said seal mounting having a plurality of circumferentially arranged members moveable radially of said axis to increase or decrease the size of the seal.

8. (canceled)

9. (canceled)

10. (canceled)

11. Chromatography apparatus employing a pump according to claim 1.

12. A piston assembly as claimed in claim 7, wherein said plurality of members each include a surface which collectively provide a conical formation and the piston assembly further includes an adjuster moveable along the axis thereby to act on the conical formation to cause said increase or decrease in size of the seal.

13. A piston assembly as claimed in claim 12, wherein the conical formation is male and the adjuster is female, and optionally, the piston further includes a rocker about which the members may pivot in use.

14. A piston assembly as claimed in claim 13, wherein the rocker has a stem for driving the piston, and the adjuster is mounted on the rocker at said stem.

15. A piston assembly as claimed in claim 7, wherein the plurality of members forming the seal mounting are resiliently attached together.

16. A piston assembly as claimed in claim 7, wherein the seal has a generally flat end supported by ends of the plurality of members.
